(19) United States
(12) Patent Application Publication
(10) Pub. No.: US 2011/0001941 A1
(43) Pub. Date: Jan. 6, 2011

(54) LAMP HOUSING UNIT

(75) Inventors: Andreas Huber, Maisach (DE); Bernhard Reiter, Muenchen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/865,132

(22) PCT Filed: Jan. 31, 2008
(86) PCT No.: PCT/EP08/51167

§ 371 Date: Jul. 29, 2010

(51) Int. Cl. G03B 21/20; F21V 15/01

(52) U.S. Cl. 353/119; 362/362

(57) ABSTRACT

A lamp housing unit for holding a lamp in an interior of a lamp housing of the lamp housing unit is provided. The lamp housing unit may include the lamp housing; and at least one sheet metal strip being fastened on the lamp housing or on an element fastened on the lamp housing, wherein the at least one sheet metal strip extends into the interior so that it can be connected to a lamp as current lead.

### TECHNICAL FIELD

The invention relates to a lamp housing unit in accordance with the preamble of patent claim 1.

### PRIOR ART

Such lamp housing units are used in video projectors (both front projectors and back projectors). In this case, the lamp housing unit can be inserted as plug-in unit into the housing of the video projector. If the lamp held in the lamp housing unit is to be replaced by a new lamp, the lamp housing unit can be removed again. This simplifies the correct adjustment of the lamp.

To date, cable lines have been used in a lamp housing unit as power supply lines for the lamp. In order to provide cable lines, it is necessary when producing the lamp housing unit to provide the actual line with suitable connecting means at two ends. For example, it is necessary for a plug connector to be crimped on at the end on the lamp side. Cable lines are, moreover, also disadvantageous because when the lamp is mounted in the lamp housing unit the cable has to be guided to a connecting point on the lamp and then must be fastened.

### SUMMARY OF THE INVENTION

The object of the present invention is to provide a lamp housing unit in accordance with the preamble of patent claim 1 that can be produced as inexpensively as possible, and in the case of which changing the lamp is simplified.

This object is achieved in the case of a lamp housing unit having the features in accordance with the preamble of patent claim 1 by the features of the characterizing part of patent claim 1. Particularly advantageous refinements are to be found in the dependent claims.

According to the invention, there is arranged fixedly in the lamp housing directly on the lamp housing or indirectly via an element fastened on the lamp housing a sheet metal strip that extends into the interior and can thereby be connected to a lamp in order to be able to be used as current lead.

When use is made of a sheet metal strip as current lead, it being preferred to provide one sheet metal strip in each case for supplying and returning current, connections can be made directly to the sheet metal strip itself, and there is thus no need to provide connecting means such as plug connectors on the sheet metal strip, and so production steps relating thereto are omitted. In addition, a sheet metal strip has a certain stiffness. This means that the end of the sheet metal strip is located more or less at a predetermined location in the interior of the lamp housing. Given suitable selection of this location, there is no need for the sheet metal strip to be bent, or at least it need not be greatly bent, when a lamp is to be connected. The lamp fitter therefore need not concern himself with positioning the sheet metal strip.

In order to be able to fix the position of the end of the sheet metal strip in the interior of the lamp housing as precisely as possible, the sheet metal strip can have a shape deviating from a rectilinear extent, that is to say can have at least one bending point or else kink by which it is preshaped, specifically in the direction of the current.

Like conventional sheet metal strips, the sheet metal strip can have a rectangular cross sectional profile and therefore already has a good stability. However, in order to increase the stability it has proved to be sensible to provide the sheet metal strip with a cross sectional profile with a nonrectangular shape. In particular, it is possible to start with a sheet metal strip having a rectangular cross sectional profile and to attain the nonrectangular shape by press molding, that is to say in that the sheet metal strip is bent in the cross sectional profile, for example by an angle of greater than 45°, and preferably by an angle of approximately 90° (between 85° and)95°. A sheet metal strip thus press molded is particularly rigid and therefore stable, and mounting of the lamp is particularly simplified.

High pressure discharge lamps (in particular including so-called extra high pressure discharge lamps) are driven by an electronic ballast. A relatively high starting voltage must be generated when starting operation. It is now possible for the electronic ballast and the electric components to be separated from one another in order to generate a starting voltage, for example so that they can be produced by different manufacturers. A printed circuit board with the electronic components for generating a starting voltage can be fastened on the lamp housing. The sheet metal strips are then provided on this printed circuit board. In this case, it is sensible for the starting voltage to lie between 1.8 and 3.2 kV, preferably between 2 and 3 kV. Given a higher starting voltage, it would be necessary to separate the sheet metal strips from one another by an insulating material so that no sparks can jump over. The air gap that is normally available in a lamp housing interior suffices in the case of the known voltages of from 2 to 3 kV.

It is now possible, in turn, to provide terminals for coupling an electronic ballast on the printed circuit board with the electronic components, these terminals requiring to be designed for a voltage of from 300 to 400 V. These lamp terminals can be designed as screw type terminal, clamp type terminal, solder terminal, or be capable of being welded or being crimped. It is also possible to provide connecting contacts as contact springs that can be connected directly to a contact surface on the electronic ballast.

As an alternative to the embodiment in the case of which the lamp housing unit supports the printed circuit board with the electronic components for generating a starting voltage, it is also possible to provide that it can be connected directly to an electronic ballast that then comprises precisely the electronics for generating a starting voltage. In this case, a connecting element for coupling an electronic ballast can be provided or constructed directly on the two sheet metal strips that are then simply fastened on the lamps housing. Here, as well, it holds true that the connecting element can be provided as a contact that can be screwed, clamped, soldered, welded or crimped, or as a contact with a contact spring.

During production in conjunction with the lamp, on the lamp side the sheet metal strips can have an eye or a fork and be able to be crimped, soldered, plugged in or welded.

The invention also covers a video projection device with an inventive lamp housing unit, in particular as a removable unit.

### BRIEF DESCRIPTION OF THE DRAWING(S)

The aim below is to explain the invention in more detail with the aid of a plurality of exemplary embodiments. In the drawings:

FIG. 1 shows, in section, a lamp housing unit in accordance with a first embodiment of the invention,

FIG. 2 shows, in section, a modification of the lamp housing unit in accordance with the first embodiment,

FIGS. 3A to 3D show possible cross sectional profiles of a sheet metal strip as can be used in the case of the invention,

FIG. 4 shows the connection of a sheet metal strip to a printed circuit board, and

FIG. 5 shows, in section, a lamp housing unit in accordance with a second embodiment of the invention.

### PREFERRED DESIGN OF THE INVENTION

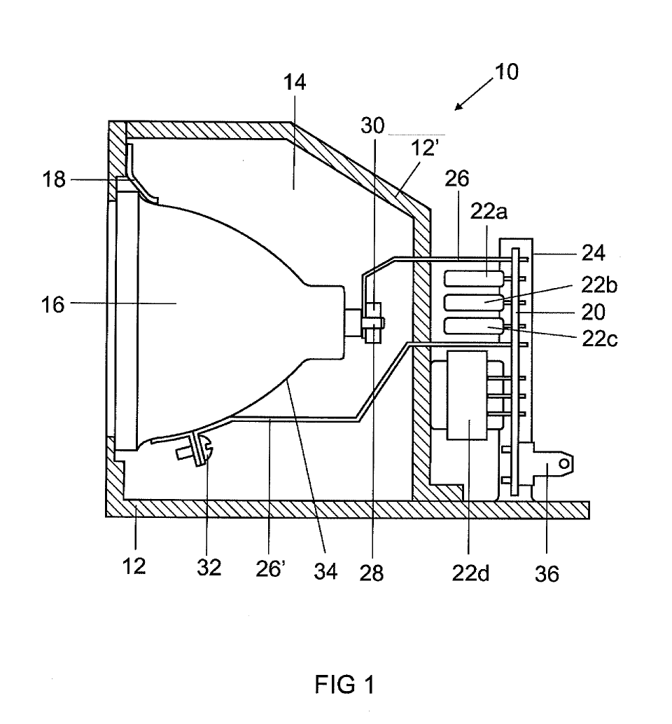

A lamp housing unit (FIG. 1) denoted as a whole by 10 has walls 12, 12′, for example made from plastic, that form the actual lamp housing and surround an interior 14 in which a high pressure discharge lamp 16 can be held. The lamp 16 is supported by a metal sheet 18.

The lamp housing unit 10 is distinguished in that it is already equipped with the electronics by means of which a starting voltage of between 2 and 3 kV can be generated for the high pressure discharge lamp 16. Corresponding electronic components 22a, 22b, 22c, 22d are arranged on a printed circuit board 20. The printed circuit board 20 itself is respectively held laterally in guides 24. It is now necessary for the voltage to be transmitted from the printed circuit board 20 to the lamp 16. To this end, sheet metal strips 26, 26′ are fastened on the printed circuit board 20. Said strips are preshaped, particularly over their longitudinal extent, in such a way that they lead exactly to the connecting points on the lamp 16: the sheet metal strip 26 has a circular cutout through which it is possible to lead a connecting pin 28 of the lamp 16 that is connected to a first electrode of the lamp burner (not shown in the figure), said pin having a thread over which a nut 30 can be screwed in order to fasten the sheet metal strip 26 on the lamp 16. The sheet metal strip 26′ likewise has at its end a bore through which it is possible to lead a threaded bolt 32 that enables the sheet metal strip 26′ to be connected to a side wall 34 of the lamp 16 at which there is provided a metal leadthrough that is connected to a second electrode of the lamp burner.

Two terminals for an electronic ballast are provided on the printed circuit board 20 so that the lamp 16 can be operated via an electronic ballast. Illustrated in the section is a connecting element or contact 36 onto which a mating contact element can be screwed or plugged. It is also possible to design the connecting element 36 such that it can be soldered, welded or crimped.

It is assumed in the case of the lamp housing unit 10 from FIG. 1 that the sheet metal strips 26 and 26′ form a rectangular cross section (perpendicular to the direction of the flow of current).

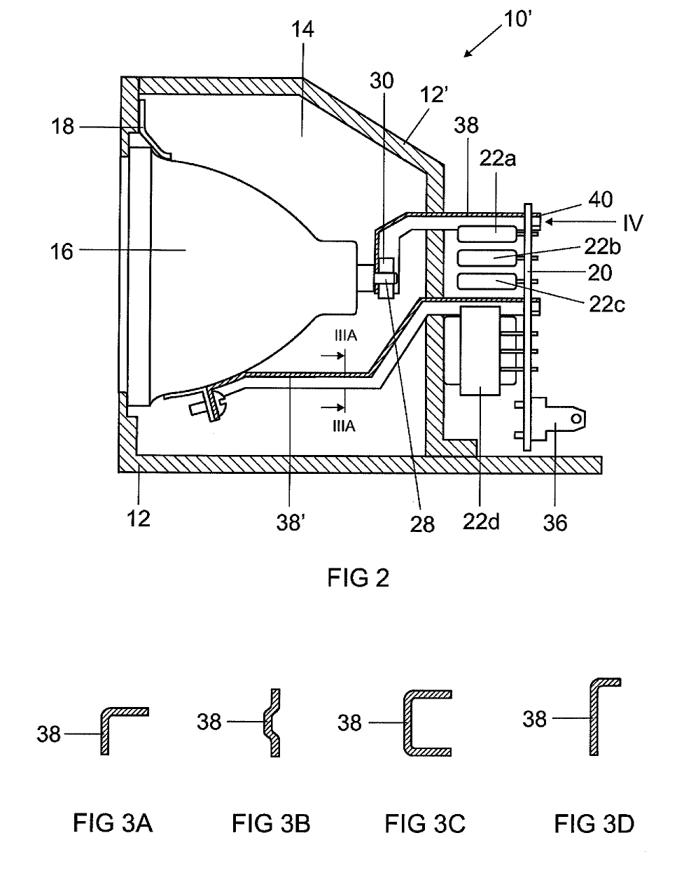

In the case of a modification of the lamp housing unit in relation to the lamp housing unit 10′ in accordance with FIG. 2, by contrast, sheet metal strips 38, 38′ are provided that have a nonrectangular cross section. Press molding was used, rather, to provide these sheet metal strips 38 and 38′ with a cross sectional profile, for example the cross sectional profile shown in FIG. 3A. As an alternative to the cross sectional profile from FIG. 3A, the sheet metal strips can also have the profiles from FIGS. 3B, 3C and 3D. The profile can thus be angular, have an L-shape or a U-shape, or have a recess as in FIG. 3B. These profiles ensure a particularly high stability of the sheet metal strips 38, 38′.

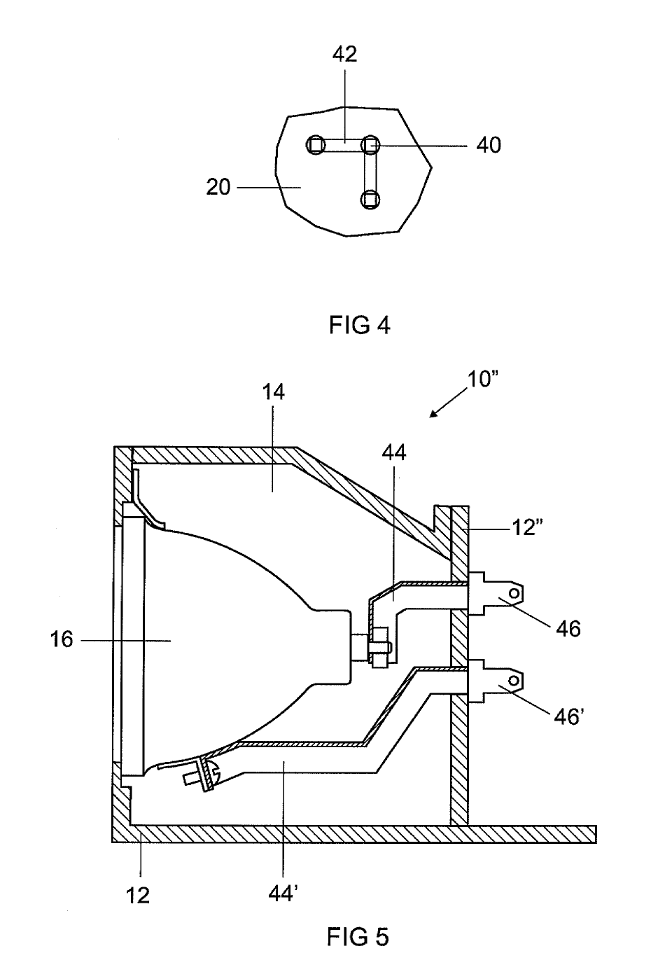

The profiling of the cross section of the sheet metal strips 38 and 38′ enables a particular type of fastening in the printed circuit board 20. This is illustrated with the aid of FIG. 4: three feet 40 on the sheet metal strip 38 project into a cutout 42 in the printed circuit board 20, and are soldered in there. As an alternative to being soldered in, they can be held in the cutout 42 in a positive locking fashion. A particularly stable arrangement results from this connection. The guide 24 can therefore be omitted.

In the case of the lamp housing units 10 and 10′ from FIG. 1 and FIG. 2, respectively, the sheet metal strips 26, 26′ and 38, 38′, are fastened on the printed circuit board 20, and connection to the electronic ballast is performed, in turn, via connecting elements 36 that are provided on the printed circuit board 20.

In a second embodiment 10″ of the inventive lamp housing unit, by contrast, the electronics for generating the starting voltage are not integrated in the lamp housing unit. Instead of this, sheet metal strips 44 and 44′, which are shown in FIG. 5 in the form of a profile as in FIG. 2 (profiles in accordance with FIGS. 3A to 3D), are fastened directly on a housing wall 12″, and connecting elements 46 and 46′ are provided directly on the sheet metal strips 44 and 44′ fastened in the housing wall 12″. Said connecting elements can have the same properties as described above for the connecting elements 36. The lamp housing unit 10″ should be coupled to an electronic ballast in which electronics are provided for generating a starting voltage. Here, as well, the starting voltage should not exceed 3 kV.

In the case of the lamp housing units 10, 10′ and 10″, the air gap between the sheet metal strips 26, 26′ and 38, 38′ and 44, 44′, suffices for no sparks to jump over given a starting voltage of 3 kV. For higher voltages, the air gap would possibly not suffice.

A third embodiment is possible in the case of which the electronic ballast is integrated in the lamp housing unit together with the electronics that provide a starting voltage.

It is possible for the lamp housing units 10, 10′ and 10″ to be built into a video projection device, and also to be capable of being removed again. Owing to the provision of the lamp housing unit as a separate unit, the lamp 16 can easily be exchanged without the need to manipulate the entire video projection device.

1. A lamp housing unit for holding a lamp in an interior of a lamp housing of the lamp housing unit, the lamp housing unit comprising:
the lamp housing; and
at least one sheet metal strip being fastened on the lamp housing or on an element fastened on the lamp housing, wherein the at least one sheet metal strip extends into the interior so that it can be connected to a lamp as current lead.

2. The lamp housing unit as claimed in claim 1,
wherein the sheet metal strip has at least one bending point or kink.

3. The lamp housing unit as claimed in claim 1,
wherein the sheet metal strip has a rectangular cross sectional profile.

4. The lamp housing unit as claimed in claim 1,
wherein the sheet metal strip has a cross sectional profile with a nonrectangular shape.

5. The lamp housing unit as claimed in claim 1, further comprising:
a printed circuit board;
wherein two sheet metal strips are provided that are fastened on the printed circuit board that supports electronic components for generating a starting voltage and is fastened on the lamp housing.

6. The lamp housing unit as claimed in claim 5,
wherein at least two terminals for coupling an electronic ballast are provided on the printed circuit board.

7. The lamp housing unit as claimed in claim 1,
wherein two sheet metal strips are provided that are fastened on the lamp housing and on which one connecting element each is constructed for the purpose of coupling an electronic ballast.

8. A video projection device, comprising:
a lamp housing unit for holding a lamp in an interior of a lamp housing of the lamp housing unit, the lamp housing unit comprising:
the lamp housing; and
at least one sheet metal strip being fastened on the lamp housing or on an element fastened on the lamp housing, wherein the at least one sheet metal strip extends into the interior so that it can be connected to a lamp as current lead.

9. The video projection device as claimed in claim 8,
wherein the lamp housing unit can be removed.
